(19) United States
(12) Patent Application Publication
(10) Pub. No.: US 2022/0278593 A1
(43) Pub. Date: Sep. 1, 2022

(54) TEMPERATURE MONITORING APPARATUS FOR GALVANOMETER MOTOR

(71) Applicant: Peijian Xu, Guangzhou (CN)

(72) Inventor: Peijian Xu, Guangzhou (CN)

(21) Appl. No.: 17/748,033

(22) Filed: May 19, 2022

(30) Foreign Application Priority Data
Sep. 3, 2021 (CN) 202122123791.5

(51) Int. Cl. H02K 11/25

(52) U.S. Cl. CPC H02K 11/25; H02K 2211/03

(57) ABSTRACT

The present disclosure provides a temperature monitoring apparatus for a galvanometer motor. The temperature monitoring apparatus includes a galvanometer motor device and a wiring board, the wiring board being mounted on the galvanometer motor device; wherein the wiring board is provided with a temperature sensor configured to monitor an operating temperature of the galvanometer motor device, the temperature sensor is proximal to a metal portion of the galvanometer motor device. No wiring is needed between the temperature sensor and the wiring board, thereby avoiding breakage of the wiring. The temperature sensor is proximal to a key heat generation position of the galvanometer motor device, thereby effectively, timely, and accurately reflecting the real operating temperature.

### TECHNICAL FIELD

The present disclosure relates to the technical field of galvanometers, and in particular, relates to a temperature monitoring apparatus for a galvanometer motor.

### BACKGROUND

A galvanometer system is a high-precision and high-speed servo control system constituted by a drive plate and a high-speed swing motor, which is widely applied in the fields such as laser material machining, biomedical detection, and image and graphics processing. The core component of a high-speed scanning galvanometer system is a galvanometer motor. A high-efficiency and high-quality galvanometer motor is capable of implementing high-speed laser marking.

The conventional galvanometer motor has always been a passively operating entity, and executes whatever command that is given. If improper human operations are performed or parameters are set too high, the galvanometer motor work in an overload fashion, and the overload may cause the motor to generate heat, which may cause demagnetization of a rotor magnet, The demagnetized motor is equivalent to a damaged motor. In the conventional galvanometer motor, a monitoring means with respect to temperatures of the motor is not provided.

To this end, a person skilled in the art may fix a temperature sensor onto a mounting base of the galvanometer motor, and monitor the temperature of the galvanometer motor by air thermal conduction. However, the following problems are present: 1) it is time consuming and less efficient to fix the temperature sensor by the epoxy resin; 2) the lead of the temperature sensor is prone to failure due to twisting and breakage during packaging and operating; 3) a delay is present in temperature monitoring; 4) the temperature sensor is too far from the heating core of the galvanometer motor, and fails to indicate the real temperature.

### SUMMARY

To overcome the defects in the related art, an object of the present disclosure is to provide a galvanometer motor apparatus for a galvanometer motor.

To achieve the above object, the present disclosure employs a technical solution of a temperature monitoring apparatus for a galvanometer motor. The temperature monitoring apparatus includes a galvanometer motor device and a wiring board, the wiring board being mounted on the galvanometer motor device; wherein the wiring board is provided with a temperature sensor configured to monitor an operating temperature of the galvanometer motor device, the temperature sensor is proximal to a metal portion of the galvanometer motor device.

The temperature sensor is coated with a highly thermally conductive epoxy resin; wherein the temperature sensor is in epoxy resin thermal contact with the metal portion of the galvanometer motor device.

Further, the wiring board is mounted at a tail end of the galvanometer motor device.

Further, the temperature sensor is a patch-like structure.

The present disclosure achieves the following beneficial effects: (1) No wiring is needed between the temperature sensor and the wiring board, thereby avoiding breakage of the wiring; (2) the temperature sensor is proximal to a key heat generation position of the galvanometer motor device, thereby effectively, timely, and accurately reflecting the real operating temperature; and (3) the mounting is simple and convenient, and the temperature sensor is pre-mounted on the wiring board.

### BRIEF DESCRIPTION OF THE DRAWINGS

For clearer description of the embodiments of the present disclosure or the technical solution in the related art, hereinafter, drawings that are to be referred for description of the embodiments or the related art are briefly described. Apparently, the drawings described hereinafter merely illustrate some embodiments of the present disclosure. Persons of ordinary skill in the art may also derive other drawings based on the drawings described herein without any creative effort.

FIG. 1 is a schematic structural view of a galvanometer motor apparatus;

FIG. 2 is a schematic exploded view of the galvanometer motor apparatus and a wiring board; and

FIG. 3 is a partial enlarged view of part A in FIG. 1.

Reference numerals and denotations thereof: 1—galvanometer motor apparatus; 2—wiring board; and 21—temperature sensor.

### DETAILED DESCRIPTION

The technical solutions according to the embodiments of the present disclosure are described in detail clearly and completely hereinafter with reference to the accompanying drawings for the embodiments of the present disclosure. Apparently, the described embodiments are only a portion of embodiments of the present disclosure, but not all the embodiments of the present disclosure. Based on the embodiments of the present disclosure, all other embodiments derived by persons of ordinary skill in the art without any creative efforts shall fall within the protection scope of the present disclosure.

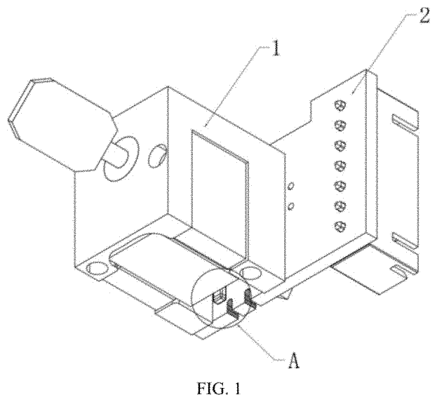

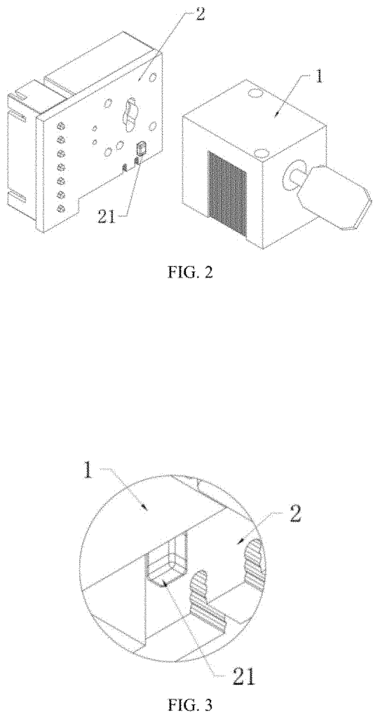

Referring to FIGS. 1 to 3, in this embodiment, a temperature monitoring apparatus for a galvanometer motor includes a galvanometer motor device 1 and a wiring board 2. The wiring board 2 is mounted on the galvanometer motor device 1. In this case, the wiring board 2 and the galvanometer motor device 1 may be fixed together by an adhesive, a screw, a snap-fit, or the like, which is not limited herein. Derived solutions may also be employed. In addition, the wiring board 2 according to this embodiment is preferably mounted at a tail end of the galvanometer motor device 1, such that a lead is led from the wiring board 2 and connected to the galvanometer motor device 1.

In this embodiment, the wiring board 2 is provided with a temperature sensor 21. In this embodiment, the temperature sensor 21 is preferably a patch-like structure. With a small structure, the connection between the wiring board 2 and the galvanometer motor device 1 is not affected. In this case, during manufacturing of the temperature sensor 21, the temperature sensor 21 may be directly mounted on the wiring board 2. During the manufacturing, the temperature sensor 21 may be detected and checked, thereby preventing on-site debugging and facilitating use. In addition, since no extra lead connection is desired, failure of the temperature sensor 21 caused by damages of the lead is prevented, and thus a better stability is achieved during packaging and use.

Further, the temperature sensor 21 is configured to monitor an operating temperature of the galvanometer motor device 1. That is, heat generated when the galvanometer motor device 1 operates is thermally conducted to the temperature sensor 21, such that the temperature sensor 21 monitors and acquires the operating temperature.

In this embodiment, the temperature sensor 21 is disposed proximally to a metal portion of the galvanometer motor device 1. In this case, the heat generated by the galvanometer motor device 1 is firstly conducted to the metal portion, and then conducted to the temperature sensor 21 disposed proximally via the metal portion, such that the temperature sensor 21 is capable of timely and accurately monitoring and acquiring the operating temperature. In this way, the actual operating temperature may be indicated.

For further quick and accurate indication of the operating temperature by the temperature sensor 21, the temperature sensor 21 according to this embodiment is coated with a highly thermally conductive epoxy resin. The temperature sensor 21 is in epoxy thermal contact with the metal portion of the galvanometer motor device 1. In this way, the heat generated by the galvanometer motor device 1 is conducted to the temperature sensor 21 via the metal portion and the epoxy resin, thereby a contact conduction effect is achieved, a heat loss during the heat conduction is lowered, and the actual operating temperature is more accurately indicated.

A person skilled in the art may present the real-time operating state of the galvanometer motor device 1 and correspondingly adjust the operating mode of the galvanometer motor device 1 by a series of judgments and control means based on the temperature acquired by detection. The judgments and control means herein are common technical means, which are not described herein any further. A person skilled in the art may reach adaptive configurations or settings in combination with corresponding control boards and control programs.

The above embodiments are used only for illustrating the present disclosure, but are not intended to limit the protection scope of the present disclosure. Various modifications and replacements readily derived by those skilled in the art within technical disclosure of the present disclosure shall fall within the protection scope of the present disclosure. Therefore, the protection scope of the present disclosure is subject to the appended claims.

What is claimed is:

1. A temperature monitoring apparatus for a galvanometer motor, comprising a galvanometer motor device and a wiring board, the wiring board being mounted on the galvanometer motor device; wherein the wiring board is provided with a temperature sensor configured to monitor an operating temperature of the galvanometer motor device, the temperature sensor is proximal to a metal portion of the galvanometer motor device.

2. The temperature monitoring apparatus for the galvanometer motor according to claim 1, wherein the temperature sensor is coated with a highly thermally conductive epoxy resin; wherein the temperature sensor is in epoxy resin thermal contact with the metal portion of the galvanometer motor device.

3. The temperature monitoring apparatus for the galvanometer motor according to claim 1, wherein the temperature sensor is mounted at a tail end of the galvanometer motor device.

4. The temperature monitoring apparatus for the galvanometer motor according to claim 1, wherein the temperature sensor is a patch-like structure.
